(19) United States
(12) Patent Application Publication
(10) Pub. No.: US 2022/0094458 A1
(43) Pub. Date: Mar. 24, 2022

(54) EMERGENCY ALERT SYSTEM MANAGEMENT IN SMART MEDIA DEVICE ECOSYSTEM

(71) Applicant: ARRIS Enterprises LLC, Suwanee, GA (US)

(72) Inventors: Virendra SINGH, Bangalore (IN); Vinod JATTI, Bangalore (IN)

(21) Appl. No.: 17/402,793

(22) Filed: Aug. 16, 2021

(30) Foreign Application Priority Data
Sep. 18, 2020 (IN) 202041040569

(51) Int. Cl. H04H 20/59; H04W 4/90; H04W 4/12; G06F 40/42

(52) U.S. Cl. CPC H04H 20/59; G06F 40/42; H04W 4/12; H04W 4/90

(57) ABSTRACT

A reliable transmission of an EAS message to a user or subscriber of a distribution source, for example, an Internet service and/or cable provider, is provided by utilizing a smart media device (SMD) ecosystem. An SMD is coupled to a distribution source, such as an Internet service provider, cable provider and/or any other service provider. The SMD can transmit the EAS message to a user of the SMD using only the SMD as opposed to relying on externally connected devices as is typically required with traditional systems. The SMD alerts a user as to an event or condition associated with an EAS message and also receives input from a user of the SMD, for example, a confirmation of the EAS message or a request for assistance. The two-way communication provided by the SMD ecosystem enhances the user experience and increases the ability to verifiably alert users to an emergency.

### BACKGROUND

The Emergency Alert System (EAS) is a national public warning system that requires broadcasters, cable television systems, wireless cable systems, satellite digital audio radio service providers and direct broadcast satellite providers to provide rapid and widespread communications capability to address the public during a national, state or local emergency. For example, since Dec. 31, 1998 cable systems with 10,000 or more subscribers per headend must install EAS equipment that is capable of providing both audio and video EAS messages. The EAS was designed in part by the Federal Communications Commission (FCC) in cooperation with the National Weather Service (NWS) and the Federal Emergency Management Agency (FEMA), in order to support the roles of each organization. The FCC provides information to broadcasters, cable system operators, and other participants in the EAS regarding the technical and operational requirements of the EAS. Additionally, the FCC ensures that state and local EAS plans conform to the FCC rules and regulations. As a result, the EAS can send messages to every subscriber's location to deliver emergency information.

Typically, an EAS message received at a subscriber's set-top box is displayed on a display device, for example, a television, attached to the subscriber's set-top box. However, if the display device is not attached to the set-top box, without power, for example, turned off or disconnected from a power outlet, and/or unavailable due to any other failure at the set-top box and/or any system connection or system device, the EAS message will not be delivered to the subscriber. Further, the EAS messaging center or generator will not be informed of the failure of the EAS message to reach all subscriber locations.

Therefore, there is a need to provide improved delivery and communication of EAS messages to subscribers. Such an improvement will significantly enhance the EAS and the ability to alert subscribers of an emergency, for example, dangerous or potentially dangerous conditions or events.

### SUMMARY

According to aspects of the present disclosure there are provided novel solutions for reliably transmitting an EAS message to a user or subscriber of a distribution source, for example, an Internet service and/or cable provider, by utilizing a smart media device (SMD) ecosystem. For example, an SMD is coupled to a backend of a distribution source, such as an Internet service provider, cable provider and/or any other service provider, the SMD can transmit the EAS message to a user of the SMD using only the elements of the SMD as opposed to relying on externally connected devices as is typically required with traditional configurations. The provided novel solutions include an SMD that provides for alerting a user as to an event or condition associated with an EAS message, such as an inclement weather condition or other emergency condition. The aspects of the present disclosure provide features that enhance the reliability and efficiency of delivering an EAS message to every user of an SMD.

An aspect of the present disclosure provides a smart media device (SMD) for transmitting an emergency alert system (EAS) message. The SMD includes a memory storing one or more computer-readable instructions and a processor configured to execute the one or more computer-readable instructions to perform one or more operations to receive the EAS message from a distribution source, select an output device of the SMD, based at least in part, on the EAS message and transmit a user message associated with the EAS message to the output device.

In an aspect of the present disclosure, the processor is further configured to execute the one or more computer-readable instructions to tune to a frequency specified in the EAS message to receive the user message, wherein the transmit the user message comprises decoding the user message and outputting the decoded user message at the output device, wherein the output device comprises an audio playback device, a video playback device or both.

In an aspect of the present disclosure, the processor is further configured to execute the one or more computer-readable instructions to perform one or more further operations to determine that the user message comprises a text message, convert the text message to audio, and wherein the transmitting the user message comprises outputting the audio at the output device, wherein the output device comprises an audio playback device.

In an aspect of the present disclosure, the processor is further configured to execute the one or more computer-readable instructions to perform one or more further operations to detect a language spoken at or about the SMD by one or more users and translate the user message based on the detected language prior to transmitting the user message.

In an aspect of the present disclosure, the processor is further configured to execute the one or more computer-readable instructions to perform one or more further operations to receive a user response to the user message, wherein the user response comprise at least one of an acknowledgement of receipt of the user message by a user, a request for assistance by the user, or a combination thereof and send a notification to the distribution source based, at least in part, on the user response.

In an aspect of the present disclosure, the SMD is coupled to one or more additional output devices, and wherein the process is further configured to execute the one or more computer-readable instructions to perform one or more further operations to select at least one of the one or more additional output devices and transmit the user message to the at least one of the one or more selected additional output devices.

In an aspect of the present disclosure, the user message comprises a multi-media message, and wherein the selected output device comprises a device that renders multi-media content.

An aspect of the present disclosure provides a method for transmitting, by a smart media device (SMD), an emergency alert system (EAS) message. The method can comprise receiving the EAS message from a distribution source, selecting an output device of the SMD, based at least in part, on the EAS message, and transmitting a user message associated with the EAS message to the output device.

In an aspect of the present disclosure, the method further comprises tuning to a frequency specified in the EAS message to receive the user message and wherein the transmit the user message comprises decoding the user message and outputting the decoded user message at the output device, wherein the output device comprises an audio playback device, a video playback device or both.

In an aspect of the present disclosure, the method further comprises determining that the user message comprises a text message, converting the text message to audio, and wherein the transmitting the user message comprises outputting the audio at the output device, wherein the output device comprises an audio playback device.

In an aspect of the present disclosure, the method further comprises detecting a language spoken at or about the SMD by one or more users and translating the user message based on the detected language prior to transmitting the user message.

In an aspect of the present disclosure, the method further comprises receiving a user response to the user message, wherein the user response comprise at least one of an acknowledgement of receipt of the user message by a user, a request for assistance by the user, or a combination thereof and sending a notification to the distribution source based, at least in part, on the user response.

In an aspect of the present disclosure, the method further comprises selecting at least one of the one or more additional output devices, wherein the SMD is coupled to one or more additional output devices and transmitting the user message to the at least one of the one or more selected additional output devices.

An aspect of the present disclosure provides a non-transitory computer-readable medium of a smart media device (SMD) for. The program when executed by a processor of the access control device, causes the access point device to perform one or more operations including the steps of the methods described above.

The above-described novel solution may be implemented at a smart media device connected to a network, for example, a connection to distribution source, according to one or more example embodiments.

Thus, according to various aspects of the present disclosure described herein, it is possible to provide a centralized access control for any number of users of various client devices connected to a network. The novel solution described herein addresses the problem of having to continuously monitor and configure various client devices that connect and/or are already connected to the network. In particular, the novel solution provides improvements for controlling access to an asset by a particular user of a client device over a network utilizing a centralized access control function.

### BRIEF DESCRIPTION OF DRAWINGS

In the drawings, like reference numbers generally indicate identical, functionally similar, and/or structurally similar elements.

FIG. 1 is a schematic diagram of a smart media device (SMD) ecosystem, according to one or more aspects of the present disclosure;

FIG. 2 is a more detailed block diagram of an SMD implemented in the SMD ecosystem of FIG. 1, according to one or more aspects of the present disclosure; and

FIGS. 3A, 3B, and 3C are flow charts illustrating a method for transmitting, by an SMD, and emergency alert system (EAS) message, according to one or more aspects of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the examples described herein can be made without departing from the spirit and scope of the present disclosure.

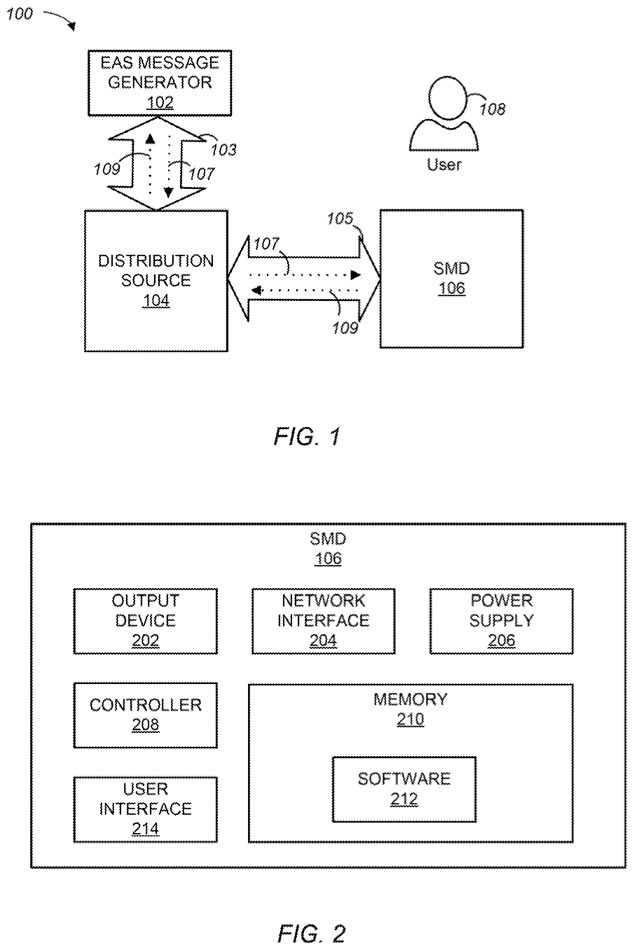

FIG. 1 is a schematic diagram of a smart media device (SMD) ecosystem 100, according to one or more aspects of the present disclosure.

It should be appreciated that various example embodiments of inventive concepts disclosed herein are not limited to specific numbers or combinations of devices, and there may be one or multiple of some of the aforementioned electronic apparatuses or network devices in the SMD ecosystem 100, which may itself consist of multiple communication networks and various known or future developed wireless connectivity technologies, protocols, devices, and the like.

The EAS is a federally managed program for communicating emergency alerts to a vast number of the population affected by an emergency condition. Alerts sent via the EAS may arrive with a portion of the EAS containing a message formatted as text, audio, video and/or multi-media content over traditional cable, over the air television, and/or satellite services. Traditional set-top/cable boxes may not provide notification of the EAS message to a user due to a display device, such as a television, not being connected or powered on. Thus, there is a need to provide the EAS message to a user without the requirement of an operational external device.

As shown in FIG. 1, the main elements of the SMD ecosystem 100 include an emergency alert system (EAS) generator 102, a distribution source 104 and an SMD 106. The EAS generator 102 generates one or more EAS messages according to information received from a federal, state and/or local source. For example, the EAS generator 102 can monitor certain frequencies or channels for information that is required to be distributed in an EAS message, receive information over a connection to a federal, state and/or local entity and/or obtain the information using any other connection and/or device. While the EAS generator 102 is shown as remote from the distribution source 104, the present disclosure contemplates any suitable location of the EAS generator 102, such as within a headend of the distribution source 104.

The EAS generator 102 is connected or coupled to the distribution source 104 via a connection 103. Connection 103 can be a bidirectional communication link such that any one or more communications or messages can be sent and received by each of the EAS message generator 102 and the distribution source 104. In one or more embodiments, when the EAS message generator 102 is part of the distribution source 104, for example, part of a headend of a cable provider, the connection 103 is an internal communication link, such as a bus, that couples the EAS message generator 102 with an interface of the distribution source 104 such that the EAS message generator 102 can be communicatively coupled to an SMD 106. The EAS message 107 can include information that directs one or more EAS compliant devices to tune to a specific frequency and program number so that the EAS message can be processed and delivered or transmitted to an appropriate device for presentation to a user such as user 108. In one or more embodiments, user 108 can be a single person or a group of a plurality of persons.

Distribution source 104 can comprise any of a headend, a cable service provider, a satellite service provider, an Internet service provider, a streaming provider, any other service provider or a combination thereof. The distribution source 104 is connected or coupled to an SMD 106 via a connection 105. Connection 105 can be a bidirectional communication link such that the communications or messages can be sent and received by each of the distribution source 104 and the SMD 106. For example, a user 108 of SMD 106 can receive an EAS message and provide a response that can be communicated back to the distribution source 104 or any other entity. Connection 105 can be implemented using any type of connection including, but not limited to, a wide area network (WAN), a virtual private network (VPN), a metropolitan area networks (MAN), a system area networks (SAN), a data over cable service interface specification (DOCSIS) network, a fiber to the premises (FTTP) (e.g., fiber to the curb (FTTC), a fiber optics network (e.g., FTTH (fiber to the home) or FTTX (fiber to the x), or a hybrid fiber-coaxial (HFC)), a digital subscriber line (DSL), a public switched data network (PSDN), a global Telex network, or a connection that supports 3rd Generation Partnership Project (3GPP) Long Term Evolution (LTE), 2G, 3G, 4G, 5G, 6G or 60 GHz network, or any combination thereof.

The SMD 106 can include a smart set-top/cable box and/or access point device that receives, decodes, and/or outputs television, satellite and/or cable signals including, but not limited to, EAS messages not associated with Mobile EAS or Wireless EAS. A set-top/cable box can include any device that can receive and/or decode over the air television signals, cable signals (such as digital television (DTV) broadcasts), and/or satellite signals (such as radio signals). An access point device can include any of a gateway (such as a residential gateway or a network gateway), an access point, a router, or any combination thereof. For example, the SMD 106 can include a tuner, such as a television tuner, that converts the source signal received to a supported output.

The SMD 106 can comprise an output device for the consumption of the supported output such as any of playback of audio, video, and/or multimedia content. In addition, the SMD 106 can include an application/software such as a visual smart assistant, an Internet of things (IoT) hub, a remote control and/or an interface to one or more external devices, connections, and/or services, or a combination thereof that is capable of receiving and/or decoding audio/video content and/or playing over-the-top (OTT), on-demand, multiple system operator (MSO), and/or EAS provided content, for example, EAS message 107, as provided by the distribution source 104. The SMD 106 can provide or deliver compelling, personalized and aggregated services in any of entertainment, home control, e-health, education, utilities, productivity, etc. or a combination thereof. The SMD 106 can be located at a user location, for example, a home or personal location, a business or office location, a public location, a governmental location, and/or any other location where an SMD is utilized.

In one or more embodiments, the distribution source 104 can receive an EAS message 107 from the EAS message generator 102 via a connection 103. The distribution source 104 transmits the EAS message 107 to the SMD 106. In one or more embodiments, in response to the EAS message 107, the SMD 106 can transmit or send a response message 109 to the distribution source 104. In one or more embodiments, the response message 109 can include a user response, an automatically generated response, or both. The user response can include an affirmative acknowledgement by a user 108 that the EAS message 107 has been received, a request for assistance, for example, a request for help from an emergency response agency, team or department, or both, such as a police and/or fire department. The automatically generated response can be a response from the SMD 106 based on a determination by the SMD 106 that the EAS message has been effectively communicated to a user 108.

The distribution source 104 can process the response message 109, transmit or send the response message 109 to the EAS generator 102, transmit or send the response message 109 to an entity that handles responses to an EAS message (for example, a 911 system, a fire department, a police department, etc.), or any combination thereof. Although FIG. 1 only shows a single SMD 106, the present disclosure contemplates that any number of SMDs 106 at one or more locations can be coupled to the distribution source 104. For example, a home networking environment can include a plurality of SMDs 106 distributed throughout the home. Similarly, the connections 103 and 105 shown in FIG. 1 are meant to be exemplary connections and are not meant to indicate all possible connections between the EAS message generator 102, the distribution source 104 and the SMD 106. Further, SMD 106 can be communicatively coupled to any one or more other devices within an SMD ecosystem 100, for example, any one or more of a server, a computer, a portable device, an electronic tablet, an e-reader, a PDA, a mobile phone such as a smart phone, a smart speaker, an IoT device, an iControl device, a portable music player with smart capabilities capable of connecting to the Internet, cellular networks, and interconnecting with other devices via Wi-Fi and Bluetooth, other wireless hand-held consumer electronic device, other computing devices, or a combination thereof such that the SMD 106 can also transmit or send the EAS message 107 to any one or more of these additional devices.

In general, it is contemplated by the present disclosure that the EAS message generator 102, the distribution source 104, and the SMD 106 include electronic components or electronic computing devices operable to receive, transmit, process, store, and/or manage data and information associated with the SMD ecosystem 100, which encompasses any suitable processing device adapted to perform computing tasks consistent with the execution of computer-readable instructions stored in a memory or a computer-readable recording medium (e.g., a non-transitory computer-readable medium).

Further, any, all, or some of the electronic components or electronic computing devices can be adapted to execute any operating system, including Linux, UNIX, Windows, MacOS, DOS, and ChromOS as well as virtual machines adapted to virtualize execution of a particular operating system, including customized and proprietary operating systems. Any, all or some of the electronic components or electronic computing devices are further equipped with components to facilitate communication with other devices over the one or more network connections to local and wide area networks, wireless and wired networks, public and private networks, and any other communication network enabling communication in the SMD ecosystem 100.

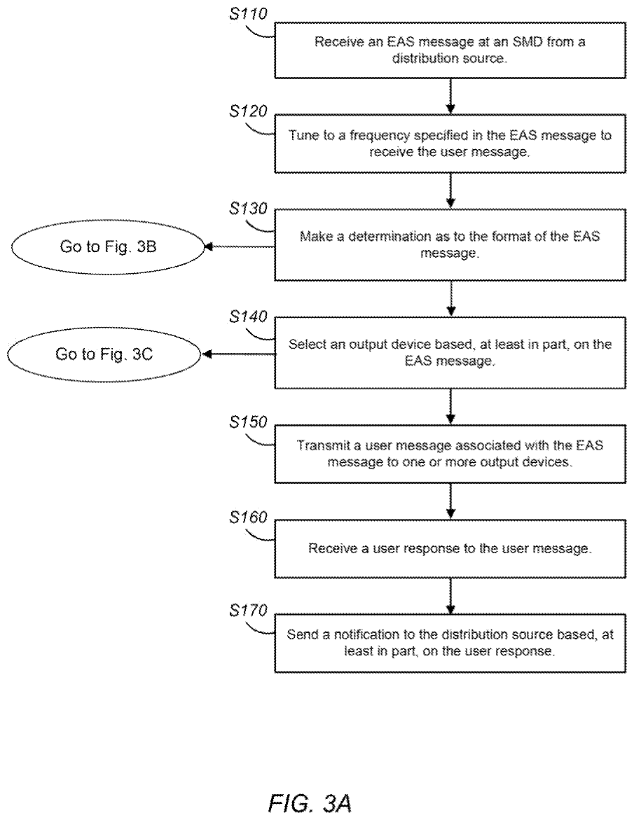

FIG. 2 is a more detailed block diagram illustrating various components of an exemplary SMD 106, implemented in the SMD ecosystem of FIG. 1, according to one or more example embodiments. The SMD 106 includes an output device 202, a network interface 204, a power supply 206, a controller 208, a memory 210, and a user interface 214.

The power supply 206 supplies power to any one or more of the internal components of the SMD 106, for example, through an internal bus. The power supply 206 can be a self-contained power source such as a battery pack with an interface to be powered through an electrical charger connected to an outlet (e.g., either directly or by way of another device). The power supply 206 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The network interface 204 can include, but is not limited to, various network cards, interfaces, and circuitry implemented in software and/or hardware to enable communications with the SMD 106 using the communication protocol(s) in accordance with connection 105 (e.g., as described with reference to FIG. 1). For example, the network interface 204 allows for communication between the SMD 106 and the distribution source 104. The network interface 204 can provide direct or indirect access to distribution source 104.

Output device 202 provides audio output, visual output, multi-media output, or any combination thereof for example, to a user 108 within a proximity of the SMD 106. Output device 202 can comprise any of a speaker, a sound bar, a display (such as a television, a monitor, a projector, and/or any other audio playback device, video playback device, or both), any other device that is capable of providing multi-media content for consumption by a user 108, or any combination thereof. For example, output device 202 can output an EAS message 107 or any portion thereof for presentation to and/or consumption by the user 108 via an internal speaker, internal display, and/or both.

The user interface 214 includes, but is not limited to, any of one or more tactile inputs (for example, a push button, a selector, a dial, etc.), a camera, a keyboard, an audio input, for example, a microphone, a keypad, a liquid crystal display (LCD), a thin film transistor (TFT), a light-emitting diode (LED), a high definition (HD) or other similar display device including a display device having touch screen capabilities so as to allow interaction between one or more users 108 and the SMD 106, or a combination thereof. For example, the user interface 214 can provide an interface associated with one or more output device settings such that a user 108 can select an internal output device 202, an externally connected output device, any one or more additional network devices coupled, directly or indirectly, or any combination thereof to the SMD 106 that should receive an EAS message 107 and/or any portions thereof. The one or more output device settings can be stored in memory 210.

The memory 210 includes a single memory or one or more memories or memory locations that include, but are not limited to, a random access memory (RAM), a dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), an optical drive, a hard disk or any other various layers of memory hierarchy. The memory 210 can be used to store any type of instructions, software, or algorithms including software 212 for controlling the general function and operations of the SMD 106 in accordance with the embodiments described in the present disclosure. In one or more embodiments, software 212 includes one or more applications and/or instructions for receiving and processing an EAS message 107 and/or sending or communicating a response message 109.

The controller 208 controls the general operations of the SMD 106 and includes, but is not limited to, a central processing unit (CPU), a hardware microprocessor, a hardware processor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software including the software 212 for controlling the operation and functions of the SMD 106 in accordance with the embodiments described in the present disclosure. Communication between any of the components (e.g., 202, 204, 206, 210, 212, and 214) of the SMD 106 can be established using an internal bus.

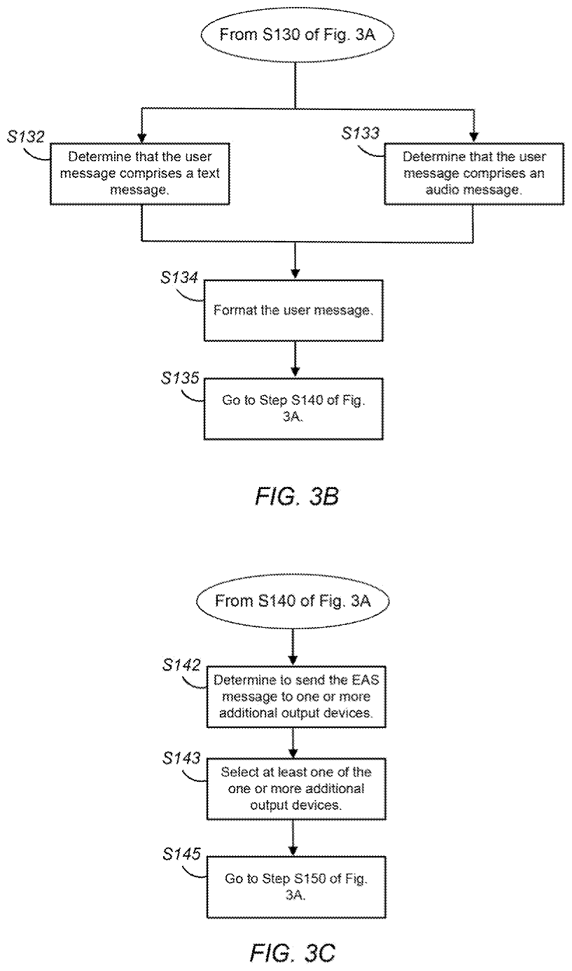

FIGS. 3A, 3B, and 3C is a flow chart illustrating a method for transmitting, by an SMD 106, and emergency alert system (EAS) message 107, according to one or embodiments of the present disclosure.

Turning to FIG. 3A, at step S110, an EAS message 107 is received at an SMD 106. For example, the EAS message 107 can be received from a distribution source 104 as discussed with reference to FIG. 1. The EAS message 107 can comprise various types of information based on the specific area message encoding (SAME) including, but not limited to, a header that can indicate originator, alert type, alert region, date and/or time, an attention signal, a user message that includes, for example, any of audio, video, image, text, or a combination thereof, and an end of message and/or tail indicator, any other information, or a combination thereof. Throughout, user message and EAS message may be used interchangeably as the user message is associated with the EAS message and/or is understood to be at least a portion of the EAS message.

At step S120, the SMD 106 can detect that the EAS message is frequency-based and can tune to a channel or frequency specified in the EAS message to receive a user message of the EAS message 107. For example, the EAS message can include information associated with a channel/frequency to receive additional information associated with the alert. In one or more embodiments, step S120 is not executed as all information is contained with the EAS message 107.

At step S130, the SMD 106 determines a format of the EAS message 107, for example, a format of a user message of the EAS message. The EAS message as discussed above can comprise audio data, video data, multi-media data, text data, image data, or any combination thereof. As illustrated in FIG. 3B, at step S132, for example, the SMD 106 can determine that the user message of the EAS message 107 comprises a text message or is text-based. In another example, the SMD 106 can determine at step S133 that the user message comprises an audio only message. At step S134, the user message of the EAS message 107 is formatted based, at least in part, on the determined format such that a text message may be converted to audio and/or an audio only message is decoded. At step S135, the process resumes at step S140 of FIG. 3A.

At step S140, the SMD 106 selects an output device 202. The output device 202 can be selected based, at least in part, on the EAS message 107, the determined format from step S130, or both. For example, the SMD 106 can determine that the EAS message 107 includes any of audio data, video data, text data, multimedia data, image data, or any combination thereof. For example, if the SMD 106 determines that the EAS message 107 only comprises audio data or text-based data (e.g., FIG. 3B), the SMD 106 can select an output device 202, such as a soundbar (for example, the text-based data can be converted to audio for presentation at the soundbar). As another example, if the SMD 106 determines that the EAS message 107 comprises multi-media data or a multi-media message, the SMD 106 can select a soundbar and a display, a display that includes audio playback capability, or any other device that renders multi-media content.

In one or more embodiments, as illustrated at FIG. 3C, at step S142 the SMD 106 can determine to send or transmit the EAS message 107 to one or more additional output devices, for example, an additional output device connected directly or indirectly, internally or externally to the SMD 106. The determination can be based, at least in part, on any of the EAS message 107 (such as the type of data in the EAS message 107, the type of alert, etc.), the available additional output devices coupled, directly or indirectly, to the SMD 106, one or more output device settings, or any combination thereof. The one or more additional output devices can include, but are not limited to, any of one or more customer premises equipment (CPE) (such as a television, a monitor, an alarm system, an emergency lighting system, an intercom system, etc.), one or more public systems (such as a public announcement system, a public loudspeaker, a public alarm system, etc.), or any combination thereof.

At step S143, the SMD 106 can select at least one of one or more additional output devices available. For example, the selection can be based, at least in part, on the determination at step S142. In one or more embodiments, the SMD 106 can also select a first output device 202 to playback one or more alert tones associated with the EAS message 107 and select a second output device 202 for presentation of one or more other portions of the EAS message 107. At step S145, the process resumes at step S150 of FIG. 3A

At step S150, the SMD 106 transmits a user message associated with the EAS message 107 to the selected output device from step S140. In one or more embodiments, the transmitting the user message can comprise decoding the user message and outputting the decoded user message at the selected output device. In one or more embodiments, at least one of one or more additional output devices are selected and the SMD 106 transmits the user message associated with the EAS message 107 to at least one of the one or more additional output devices. In one or more embodiments, the user message is the EAS message 107 and/or a user portion of the EAS message 107.

In one or more embodiments, the SMD 106 can detect a language spoken at or about the SMD 106 by any one or more users, determine a language spoken by any one or more users based on a stored language setting in memory 210, any other setting or criteria, or any combination thereof. The user message associated with the EAS message can be translated based, at least in part, on the detected language, the determined language, any other setting or criteria, or any combination thereof. Then this translated user message can be transmitted as discussed with reference to step S150.

At step S160, a user response 109 is received by the SMD 106. The user response 109 can be an acknowledgement or confirmation from a user 108 of receipt or consumption of the EAS message 107 (or the user message associated with the EAS message), a request for assistance, or both. For example, the SMD 106 can detect a voice command or perform a voice recognition that identifies a user 108 and/or a command. A user 108 within a proximity of the SMD 106 can speak one or more words or phrases, such as “MESSAGE RECEIVED” or “ACKNOWLEDGE”, to indicate that the EAS message 107 was received by the user 108. A user 108 can also speak one or more other words or phrases, such as “HELP”, to indicate the user 108 needs assistance and such can be formatted and transmitted or sent as a user response 109 to the distribution source 104.

At step S170, the SMD 106 sends a notification to a distribution source 104 based, at least in part on the user response 109. The distribution source 104 can send the notification to the EAS message generator 102, an emergency response departments, such as a first department, police department, emergency medical service provider, 911 operator, an alarm services company, any other entity that provides services required by a user 108, or any combination thereof.

According to some example embodiments of inventive concepts disclosed herein, there are provided novel solutions for providing an EAS message to a user independent of the operational status of external devices. The SMD ecosystem novel solution provides a significant improvement over traditional systems as the novel SMD ecosystem provides alerts to users without requiring any additional devices to present the EAS message. EAS messages are conveyed to users more efficiently and expeditiously. The novel SMD ecosystem also provides for multiple methods of delivering the EAS message such that multiple users can receive the EAS message in multiple languages ensuring that all users receive and understand the EAS message. Further the novel SMD ecosystem provides a two-way communication so that the user can provide real-time feedback regarding the EAS message. Such a two-way communication can improve the health and safety of a user by providing information to emergency response personnel.

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. A smart media device (SMD) for transmitting an emergency alert system (EAS) message, comprising:
a memory storing one or more computer-readable instructions; and
a processor configured to execute the one or more computer-readable instructions to perform one or more operations to:
receive the EAS message from a distribution source;
select an output device of the SMD, based at least in part, on the EAS message; and
transmit a user message associated with the EAS message to the output device.

2. The SMD of claim 1, wherein the processor is further configured to execute the one or more computer-readable instructions to perform one or more further operations to:
tune to a frequency specified in the EAS message to receive the user message; and
wherein the transmit the user message comprises:
decoding the user message; and
outputting the decoded user message at the output device, wherein the output device comprises an audio playback device, a video playback device or both.

3. The SMD of claim 1, wherein the processor is further configured to execute the one or more computer-readable instructions to perform one or more further operations to:
determine that the user message comprises a text message;
convert the text message to audio; and
wherein the transmitting the user message comprises:
outputting the audio at the output device, wherein the output device comprises an audio playback device.

4. The SMD of claim 1, wherein the processor is further configured to execute the one or more computer-readable instructions to perform one or more further operations to:
detect a language spoken at or about the SMD by one or more users; and
translate the user message based on the detected language prior to transmitting the user message.

5. The SMD of claim 1, wherein the processor is further configured to execute the one or more computer-readable instructions to perform one or more further operations to:
receive a user response to the user message, wherein the user response comprise at least one of an acknowledgement of receipt of the user message by a user, a request for assistance by the user, or a combination thereof; and
send a notification to the distribution source based, at least in part, on the user response.

6. The SMD of claim 1, wherein the SMD is coupled to one or more additional output devices, and wherein the process is further configured to execute the one or more computer-readable instructions to perform one or more further operations to:
select at least one of the one or more additional output devices; and
transmit the user message to the at least one of the one or more selected additional output devices.

7. The SMD of claim 1, wherein the user message comprises a multi-media message, and wherein the selected output device comprises a device that renders multi-media content.

8. A method for transmitting, by a smart media device (SMD), an emergency alert system (EAS) message, the method comprising:
receiving the EAS message from a distribution source;
selecting an output device of the SMD, based at least in part, on the EAS message; and
transmitting a user message associated with the EAS message to the output device.

9. The method of claim 8, further comprising:
tuning to a frequency specified in the EAS message to receive the user message; and
wherein the transmit the user message comprises:
decoding the user message; and
outputting the decoded user message at the output device, wherein the output device comprises an audio playback device, a video playback device or both.

10. The method of claim 8, further comprising:
determining that the user message comprises a text message;
converting the text message to audio; and
wherein the transmitting the user message comprises:
outputting the audio at the output device, wherein the output device comprises an audio playback device.

11. The method of claim 8, further comprising:
detecting a language spoken at or about the SMD by one or more users; and
translating the user message based on the detected language prior to transmitting the user message.

12. The method of claim 8, further comprising:
receiving a user response to the user message, wherein the user response comprise at least one of an acknowledgement of receipt of the user message by a user, a request for assistance by the user, or a combination thereof; and
sending a notification to the distribution source based, at least in part, on the user response.

13. The method of claim 8, further comprising:
selecting at least one of the one or more additional output devices, wherein the SMD is coupled to one or more additional output devices; and
transmitting the user message to the at least one of the one or more selected additional output devices.

14. The method of claim 8, wherein the user message comprises a multi-media message, and wherein the selected output device comprises a device that renders multi-media content.

15. A non-transitory computer-readable medium of a smart media device (SMD) storing a program for transmitting an emergency alert system (EAS) message to an output device of the SMD, which when executed by a processor of the SMD, causes the SMD to perform one or more operations comprising:
receiving the EAS message from a distribution source;
selecting an output device of the SMD, based at least in part, on the EAS message; and
transmitting a user message associated with the EAS message to the output device.

16. The non-transitory computer-readable medium of claim 15, wherein the program, when further executed by the processor, causes the SMD to perform one or more further operations comprising:
tuning to a frequency specified in the EAS message to receive the user message; and
wherein the transmit the user message comprises:
decoding the user message; and
outputting the decoded user message at the output device, wherein the output device comprises an audio playback device, a video playback device or both.

17. The non-transitory computer-readable medium of claim 15, wherein the program, when further executed by the processor, causes the SMD to perform one or more further operations comprising:
determining that the user message comprises a text message;
converting the text message to audio; and
wherein the transmitting the user message comprises:
outputting the audio at the output device, wherein the output device comprises an audio playback device.

18. The non-transitory computer-readable medium of claim 15, wherein the program, when further executed by the processor, causes the SMD to perform one or more further operations comprising:
detecting a language spoken at or about the SMD by one or more users; and
translating the user message based on the detected language prior to transmitting the user message.

19. The non-transitory computer-readable medium of claim 15, wherein the program, when further executed by the processor, causes the SMD to perform one or more further operations comprising:
receiving a user response to the user message, wherein the user response comprise at least one of an acknowledgement of receipt of the user message by a user, a request for assistance by the user, or a combination thereof; and
sending a notification to the distribution source based, at least in part, on the user response.

20. The non-transitory computer-readable medium of claim 15, wherein the program, when further executed by the processor, causes the SMD to perform one or more further operations comprising:
selecting at least one of the one or more additional output devices, wherein the SMD is coupled to one or more additional output devices; and
transmitting the user message to the at least one of the one or more selected additional output devices.
